(19) United States
(12) Patent Application Publication
(10) Pub. No.: US 2025/0210014 A1
(43) Pub. Date: Jun. 26, 2025

(54) HYBRID DRUM SHELLS AND RELATED METHODS

(71) Applicant: Drum Workshop, Inc., Oxnard, CA (US)

(72) Inventor: John GOOD, Oxnard, CA (US)

(21) Appl. No.: 18/434,670

(22) Filed: Feb. 6, 2024

Related U.S. Application Data
(60) Provisional application No. 63/614,037, filed on Dec. 22, 2023.

(51) Int. Cl. G10D 13/22; G10D 13/02; G10D 13/24

(52) U.S. Cl. CPC G10D 13/22; G10D 13/02; G10D 13/24

(57) ABSTRACT

Disclosed herein are hybrid drum shells and methods of forming such hybrid drum shells. Some embodiments include wood in addition to metal and/or another non-wood material. For instance, one or more metal (or other non-wood) plies or stave portions can be included. The inclusion of a non-wood element alters the vibration characteristics of the drum when struck by a drummer, thereby resulting in a unique sound profile that may be tuned by, for example, material selection.

### CROSS-REFERENCE TO RELATED APPLICATIONS

This application claims the priority benefit of U.S. Provisional Pat. App. No. 63/614,037 to Good et al., filed on Dec. 22, 2023 and entitled “Hybrid Drum Shells and Related Methods,” the contents of which are fully incorporated by reference herein.

### BACKGROUND

### 1. Field of the Disclosure

The present disclosure relates to musical instruments; specifically to percussion instruments; and even more specifically to musical instruments having components such as drum shells made of a hybrid of different materials, as well as related methods.

### 2. Description of the Related Art

While solid wood drum shells exist, many drum shells manufactured today include multiple plies of wood or other multi-segment constructions, such as segmented shells or staved shells. The use of multiple plies or segments can provide strength and/or decrease warping over solid drum shells, provide a more desirable aesthetic, and may provide a different sound. In prior art methods, plywood is formed from multiple plies of wood (e.g., via gluing), and then the plywood is scarfed such that the ends of a plywood sheet will fit with one another and form a strong joint when the plywood is rolled into the typical cylindrical drum shell shape. For example, FIG. 1A shows a drum 100 with a drum shell 102 shown in FIG. 1B and made from plywood. FIG. 1C shows a top view of the prior art drum shell 102 in which it can be seen that the drum shell 102 is comprised of several pieces of plywood adhered together and rolled to form a cylindrical shape.

One typical drum shell construction available from Drum Workshop, Inc. utilizes three pieces of plywood 104a, 104b, 104c each having three plies 106a, 106b, 106c. The plies 106a, 106b, 106c are connected to one another, such as with an adhesive such as glue, epoxy, or in another manner. The pieces of plywood 104a, 104b, 104c are then rolled into a cylinder with their ends connected at a respective joint 108 for each piece of plywood 104a, 104b, 104c, such as for example, a scarf joint, a butt joint, and other joints known in the art. In the shell construction available from Drum Workshop, Inc., the plywood joints 108 are approximately equally spaced around the circumference of the shell.

### SUMMARY OF THE DISCLOSURE

One embodiment of a drum shell according to the present disclosure comprises a first wood ply, a second wood ply, and a non-wood ply between the first and second wood plies.

One method of manufacturing a hybrid drum shell according to the present disclosure comprises combining a wood ply and a non-wood ply into a hybrid ply sheet, and rolling the hybrid ply sheet into a substantially cylindrical shape.

Another embodiment of a drum shell according to the present disclosure comprises a plurality of staves connected to form a generally cylindrical shape. The plurality of staves includes a plurality of wood staves and a plurality of non-wood staves.

This has outlined, rather broadly, the features and technical advantages of the present disclosure so that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further features and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE FIGURES

The features and advantages of the various exemplary embodiments will become apparent from the following detailed description when considered in conjunction with the accompanying drawings. Where possible, the same reference numerals and characters are used denote 1 features, elements, to components or portions of the inventive embodiments. It is intended that changes and modifications can be made to the described exemplary embodiments without departing from the true scope and spirit of the inventive embodiments described herein as defined by the claims.

FIG. 1A is a perspective view of a prior art drum with a wooden drum shell;

FIG. 1B is a top view of the drum shown in FIG. 1A, with the drum head removed;

FIG. 1C is a is a magnified view of a portion of the top of the drum shell shown in FIG. 1B;

FIG. 2A is a top view of one embodiment of a hybrid drum shell according to the present disclosure;

FIG. 2B is a perspective view of the hybrid drum shell shown in FIG. 2A;

FIG. 3 is an exploded view of a hybrid ply sheet used in the hybrid drum shell shown in FIGS. 2A and 2B; and

FIG. 4 is a perspective view of another embodiment of a hybrid drum shell according to the present disclosure;

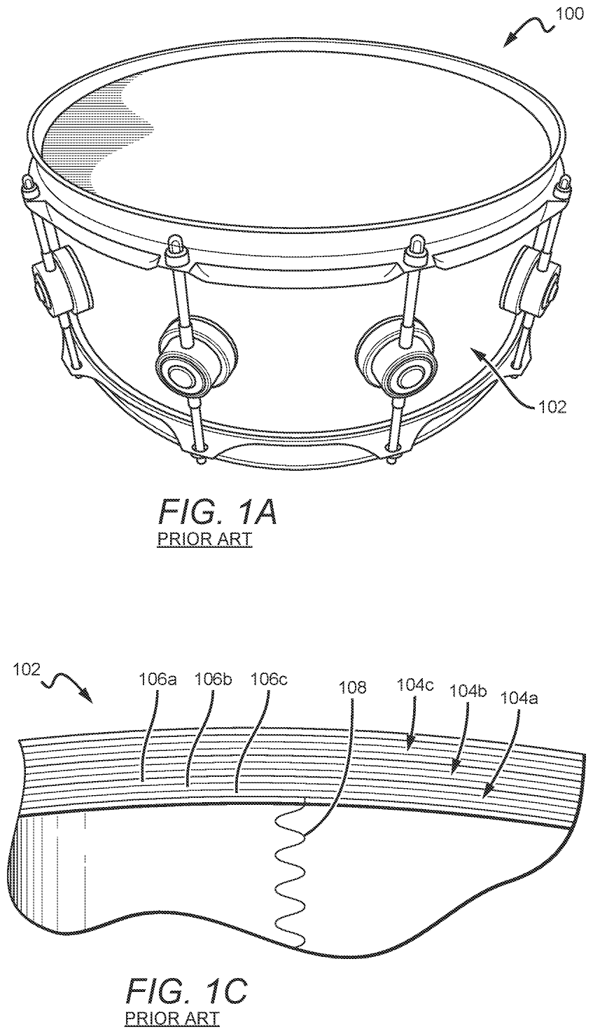

### DETAILED DESCRIPTION OF THE DISCLOSURE

Disclosed herein are hybrid drum shells and methods related thereto. Some drum shells according to the present disclosure include both wood and non-wood (e.g., metal) components, such as one or more metal plies or segments. The inclusion of a metal element in addition to traditional wood elements alters the sound produced by the drum when struck by a user relative to a fully wooden construction. Hybrid drum shells other than wood/metal shells, such as wood/composite, wood/plastic, wood/carbon fiber, and woodless hybrid embodiments, are also described, as are hybrid shells utilizing combinations of different wood.

In the following detailed description, numerous specific details are set forth in order to provide a more thorough understanding of embodiments incorporating features of the present disclosure. However, it will be apparent to one skilled in the art that devices, methods, and assemblies according to the present disclosure can be practiced without necessarily being limited to these specifically recited details.

Embodiments of the disclosure are described herein with reference to illustrations that are schematic illustrations of embodiments of the disclosure. As such, the actual size, components and features can be different, and variations from the shapes of the illustrations as a result, for example, of technological capabilities, manufacturing techniques and/or tolerances are expected. Embodiments of the disclosure should not be construed as limited to the particular shapes or components of the regions illustrated herein but are to include deviations in shapes/components that result, for example, from manufacturing or technological availability. The regions illustrated in the figures are schematic in nature and their shapes are not intended to illustrate the precise shape or functionality of a feature of a device and are not intended to limit the scope of the disclosure. In addition, components may be shown as one unit but may instead be a collection of components or units, or a collection of components or units may exist as one unit.

Throughout this description, the preferred embodiment and examples illustrated should be considered as exemplars, rather than as limitations on the present disclosure. As used herein, the term “disclosure,” “device,” “assembly,” “system” “method,” “present disclosure,” “present device” or “present method” refers to any one of the embodiments of the disclosure described herein, and any equivalents. Furthermore, reference to various feature(s) of the “disclosure,” “device,” “assembly,” “system,” “method,” “present disclosure,” “present device” or “present method” throughout this document does not mean that all claimed embodiments or methods must include the referenced feature(s).

It is also understood that when an element or feature is referred to as being “on” or “adjacent” another element or feature, it can be directly on or adjacent to the other element or feature, or intervening elements or features may also be present. It is also understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Relative terms such as “outer,” “above,” “lower,” “below,” “horizontal,” “vertical” and similar terms, may be used herein to describe a relationship of one feature to another. It is understood that these terms are intended to encompass different orientations in addition to the orientation depicted in the figures.

Although the terms first, second, etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure. As used herein, the term “and/or” includes any and all combinations of one or more of the associated list items.

The terminology used herein is for describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” when used herein, specify the presence of stated features, integers, steps, operations, elements, and/or components, but do not preclude the presence or addition of one or more other features, integers, steps, operations, elements, components, and/or groups thereof.

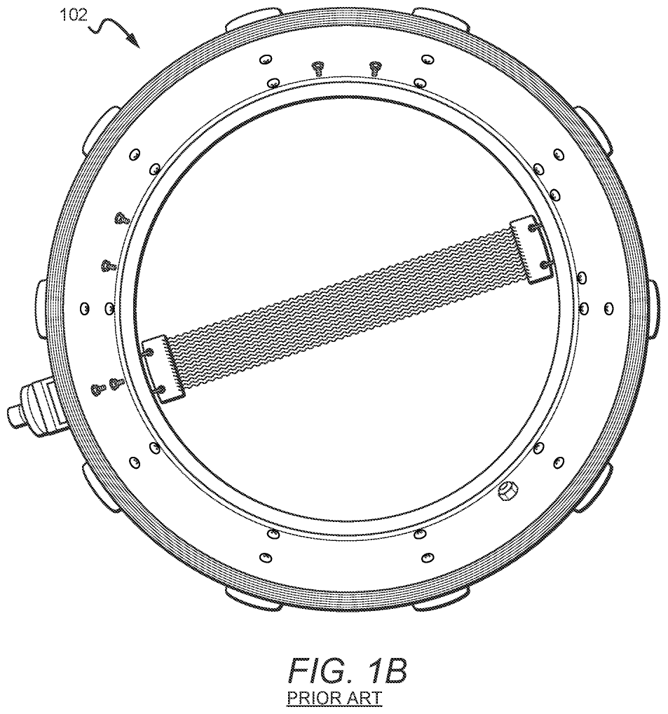

FIGS. 2A and 2B show an embodiment of a hybrid drum shell 200 according to the present disclosure. The shell 200 can include one or more ply sheets. In the specific embodiment shown, the shell 200 includes two plywood ply sheets 208a, 208b, and one hybrid ply sheet 204. It should be understood that any number of ply sheets are possible, that ply sheets can include any number of individual plies, and that the different ply sheets can include the same or different numbers and types of plies.

In the specific embodiment shown, the innermost ply sheet 208a and the outermost ply sheet 208b are both three-ply plywood, and the intermediate ply sheet 204 is a hybrid ply sheet including three plies 206a, 206b, 206c. The plies 206a, 206c are wood, and can be the same type or a different type of wood used for the plywood sheets 208a, 208b. The hybrid ply sheet 204 also includes at least one ply that is not the same material as the other plies in the sheet; in this case, a non-wood ply 206b (though it should be understood that all-wood hybrids are also possible, using different types of wood). The non-wood ply 206b can be, for instance, metal (e.g. aluminum, steel, brass, copper, bronze, titanium, alloys, etc.), carbon fiber, plastics (e.g. polyethylene, polyvinyl chloride, polypropylene, polystyrene, etc.), fiberglass, and/or other materials as would be understood by one of skill in the art, as well as combinations of any of these. Throughout the present disclosure, non-wood plies may be referred to as a “metal ply” or “metal plies” for simplicity, but it should be understood that any non-wooden material or combination of materials is possible, or that a different type of wood is possible.

In one embodiment of a method of manufacturing a hybrid drum shell 200 according to the present disclosure, the plies in each ply sheet are adhered together, such as using an adhesive. The ply sheets 204, 208a, 208b are then rolled to form the shell 200. In a traditional construction, the individual plies are approximately 1/36 inch thick. In even more specific embodiments, nine individual plies 206 are used to achieve a total hybrid drum shell 200 thickness of approximately ¼ inch. A non-wood ply may have a smaller thickness (e.g. less than 1/36 inch and/or less than one or more of the wood plies in the same shell), which can help in rolling the non-wood and/or formation of the drum shell. It is understood that the aforementioned thicknesses are exemplary in nature and not intended to limit this disclosure, and understood that the non-wood ply/plies can also have the same or greater thickness than wood plies in some embodiments. It should be understood that any number of ply sheets, plies per sheet, thicknesses, and material combinations can be used.

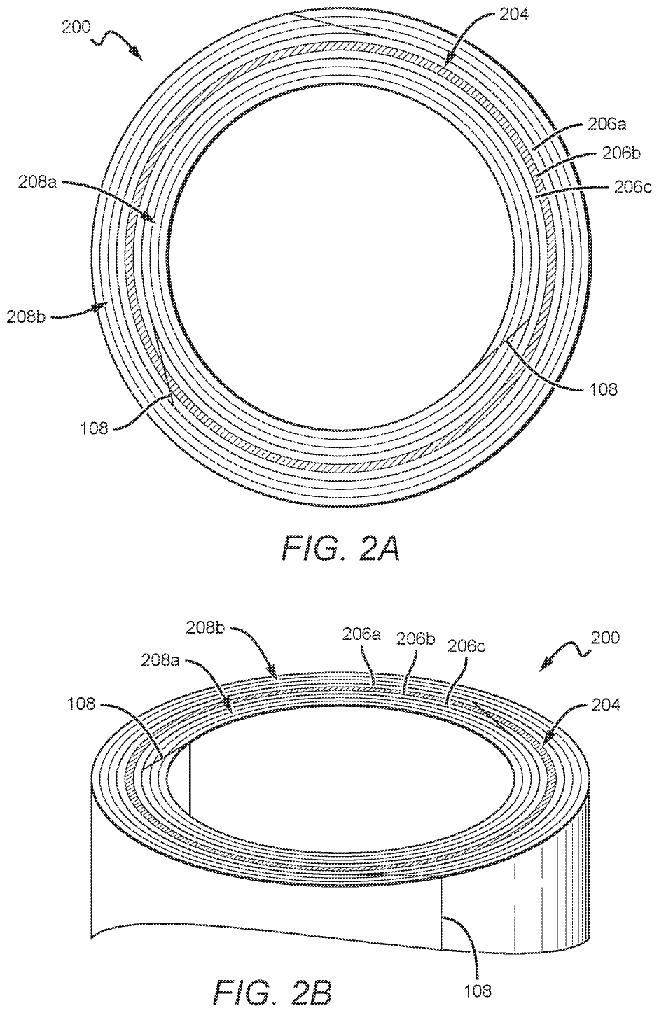

In the specific embodiment shown, the hybrid ply sheet 204 comprises three or more individual plies 206a, 206b, 206c. The exterior plies (i.e. the plies with the largest radius and the smallest radius, 206a and 206c in FIGS. 2A-3) are wooden and/or the same material as the material they adjoin (e.g., of the ply sheets 208a, 208c), and one or more interior plies is a non-wooden material (e.g. 206b in FIGS. 2A-3), such as those materials discussed above.

It should also be understood that, rather than a different material altogether, the “metal ply” may simply be a different species of wood than the wooden plies. For instance, plies 206a, 206c may be made of maple, while ply 206b is made of black walnut. Many different species of wood are contemplated by this disclosure including without limitation maple, black walnut, birch, oak, poplar, wenge, jatoba, mahogany, kapur, beech, cherry, bubinga, and ash.

Additionally, while three ply sheets 204, 208a, 208b are shown in FIGS. 2A-2B, it is understood that fewer or more ply sheets 204, 208a, 208b are contemplated, as are fewer or more than three individual plies 206 that form the ply sheets 204, 208a, 208b. It should also be understood that while FIGS. 2A-3 show only a single hybrid ply sheet 204, any number of the ply sheets used (including all of the ply sheets) could be the same or different types of ply sheets.

Many different using embodiments different permutations of metal plies and wooden plies are possible. For instance, the innermost ply (e.g. 206c) may be a metal ply, while the intermediate and/or outermost plies (e.g. 206a, 206b) may be wooden. In other embodiments, the outermost ply (e.g. 206a) may be a metal ply, while the middle and/or innermost plies (e.g. 206b, 206c) may be wooden. In other embodiments, both the innermost and outermost plies (e.g. 206a, 206c) may be metal plies, while the middle ply may be wooden. In yet other embodiments, adjacent plies (e.g. 206a, 206b or 206b, 206c) may both be metal plies with the remaining ply being wooden. In other embodiments, all plies 206a, 206b, 206c may be metal plies. It is understood that many different combinations of ply sheets 204, 208a, 208b with differing or identical ply material combinations as described above are possible. Moreover, it should be understood that a ply sheet could be made of a single material or single ply; for instance, in one embodiment, all the plies or the singular ply of an intermediate ply sheet are metal, and that ply sheet is surrounded by ply sheets of wood.

Additionally, the drum shell composition can, in some embodiments, comprise (by volume) 2% or more metal, 5% or more metal, 10% or more metal, 25% or more metal, 33% or more metal, 50% or more metal, 75% or more metal, 90% or more metal, 90% or less metal, 75% or less metal, 50% or less metal, 33% or less metal, 25% or less metal, 10% or less metal, 5% or less metal, or 2% or less metal, or combination ranges of these (e.g., a range of 5% to 25% metal). The percentages above are exemplary only and are not intended to limit this disclosure. It is understood that many other percentages of metal ply are possible and are contemplated by this disclosure, and that non-woods other than metal are also possible.

After the one or more ply sheets 204, 208a, 208b have been created, they may be rolled into a generally cylindrical shape and their respective ends adhered together to form a cylinder, such as by using an adhesive. The ends of each ply sheets 204, 208a, 208b may be prepared to form a joint 108, such as a scarf joint, butt joint, or others known in the art, to improve the quality of the adhesion between the ends. As discussed in more detail below, the location of the joints of various ply sheets can be spread around the circumference of the shell (e.g. equidistantly) in order to avoid the formation of a single week point. For instance, in a drum of three ply sheets 204, 208a, 208b, the joints 108 can be more than 90° (e.g. approximately 120°) from one another.

The inclusion of one or more metal plies affects the drum shell vibration when struck by a drummer, thereby affecting the sound profile of the instrument, such as for example its tone, texture, timbre, sustain, and volume. In some embodiments according to the present disclosure, one or more materials are selected for the metal ply to achieve a particularly desirable sound profile. As a result, the hybrid drum shell 200 provides drummers with increased customization options, as well as artistic expression, relative to the prior art.

Given that wood plies and metal plies are made of different materials, traditional plywood manufacturing processes are less effective and can result in poor bonds between plies. For example, traditional wood glues may not bond well to metal plies. As a result, in one method of manufacturing a drum shell with a hybrid drum shell 200 according to the present disclosure, a multi-material adhesive is selected specifically to bond the wood plies to the metal plies, such as for example industrial strength epoxy, polyurethane glue, cyanoacrylate, poly vinyl acetate, and other adhesives known in the art. In some embodiments of methods according to the present disclosure, the surface area of one or both of one or more ply's mating surfaces (i.e. the surface that would mate with other plies) is increased, such as by roughening, abrasion, etching (such as by chemical or laser), scratching, grinding, rolling, sanding, a combination of one or more of the foregoing, or other methods known in the art. This step improves the ability of the adhesive to bond to the metal ply. In some embodiments according to the present disclosure, prior to adhering the ends of one or more ply sheets 204, the surface areas of the ends of the one or more ply sheets 204 are increased in a fashion similar to that described above to improve the mating surface bonds.

In some embodiments, individual plies are scarfed prior to being attached to one another to form ply sheets and/or prior to being rolled into a generally cylindrical shape for use as a drum shell. In other embodiments, the ply sheets 204, 208a, 208b are scarfed after the individual plies 206a, 206b, 206c are attached to one another to form ply sheets. In certain embodiments according to the present disclosure, the joints 108 of the various ply sheets can be staggered or placed at different points radially around the circumference of the drum shell. In one embodiment of the present disclosure, two or more joints 108 from different ply sheets are separated or offset (the term “separated” used hereafter for simplicity) from one another by 5° or more; in another embodiment, 10° or more; in another embodiment, 15° or more; in another embodiment, 22.5° or more; in another embodiment, 45° or more; in another embodiment, 60° or more; in another embodiment, 75° or more; in another embodiment, 90° or more; in another embodiment, 120° or more; in another embodiment, 135° or more; in another embodiment, 150° or more; in another embodiment, 165° or more; and in another embodiment, approximately 180°. In some embodiments, the separation between joints is achieved by dividing 360° by the number of joints, i.e. the number of ply sheets, with a permitted manufacturing variance, such as ±5°, ±10°, or ±25°, for example.

The separation of joints 108 can result in the elimination of a weak point of a traditionally scarfed drum shell: the radial point where all plies have a joint; and/or can result in the weakest point radially about the drum being stronger than the weakest point of a traditionally scarfed drum shell. Embodiments of the present disclosure can include any number of plies and ply sheets (or combinations of plies) and any number of joints 108, including but not limited to two plies (or ply combinations), three plies, four plies, five plies, eight plies, ten plies, or more, and/or including one joint, two joints, three joints, four joints, five joints, six joints, seven joints, eight joints, nine joints, ten joints, or more. Similarly, embodiments of the present disclosure can have any number of ply sheets, including without limitation one ply sheet, two ply sheets, three ply sheets, four ply sheets, five ply sheets, or more. It should be clear to one of skill in the art that the number of joints, ply sheets, and individual plies listed above are not intended to limit this disclosure and instead are provided as examples only. It should also be understood that single-ply ply sheets are also envisioned. By way of example, one specific embodiment of the present disclosure that will be more fully described below includes a ply sheet of a single metal ply, surrounded by wood ply sheets to its inside and outside.

Additionally, in another embodiment, different types of scarf joints can be used for different ply sheets. For example, the outermost ply sheet 208b and/or the outermost individual ply 206 can include a more secure joint 108 which may be more difficult and/or expensive to make, such as a scarf joint including male/female, protrusion/recession, and/or tab/slot style connections. In addition, mechanical fasteners such as screws, nails, bars, mesh, metal reinforcement, and other mechanical fasteners as would be understood by one of skill in the art could also be used at the outermost joint 108 to increase its strength. Inclusion of a more secure joint 108 in the outermost ply sheet and/or individual ply can be more important to the structural integrity of the drum shell than with inner plies, and as such in some embodiments the inner plies may not include such elements, but could, for example, be a simple angled scarf joint such that the two ends of each of the plies become flush with one another. It is understood that while this paragraph discusses different types of joints 108 and/or mechanical fasteners for use with the outermost ply sheet and/or individual ply, these same concepts can be applied to inner plies in addition to or in place of the outermost ply.

Individual plies 206a, 206b, 206c can be scarfed together while still not being permanently attached to one another. For instance, one ply can be placed on top of one another such that the ends of the two plies line up with one another, and then the ends of the plies scarfed at the same time. The individual plies 206a, 206b, 206c can then be attached to one another.

In another embodiment, a first ply 206a (or combination of plies) can be rolled and its ends attached to one another, and then each successive ply 206b, 206c (or combination of plies) rolled therearound. Joint formation can occur after each successive ply or combination of plies is rolled. In some embodiments, each successive ply is attached as it is rolled around the previous ply.

In some embodiments, a metal individual ply 206 (or a combination of multiple metal plies) is formed into a cylindrical shape (and may or may not be treated to increase its surface area as discussed above for enhanced bonding). The metal ply 206 may then be attached to wood plies and/or ply sheets to its inside and outside. In some embodiments, adhesive is applied between the metal individual ply 206 and the adjacent plies/ply sheets before a clamp is used to improve bonding by applying pressure to the plies orthogonal to their mating surfaces. As one of skill in the art would understand, many different clamping setups are possible, including without limitation hose clamps, straps, semi-cylindrical clamps, dies, and others known in the art. Other bonding methods are also possible, as are other locations of the individual ply 206 (e.g., as the innermost or outermost ply of the shell).

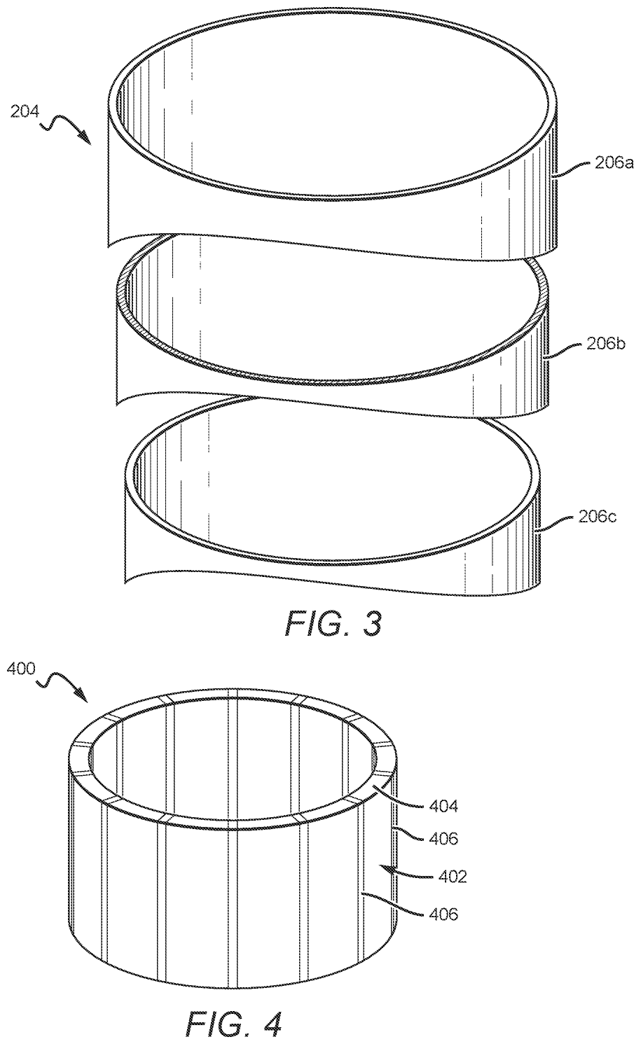

While the description above related to ply-constructed hybrid drum shells 200, other shell constructions may also utilize the above concepts such as (but not limited to) a metal element (“metal element” here is used in the same manner as “metal ply” above to refer to a plethora of materials). For example, a metal element can be included in the manufacturing of stave drum shells, segmented drum shells, and others known in the art. FIG. 4 shows a stave drum shell 400 according to another embodiment of the present disclosure. The stave drum shell 400 comprises multiple stave segments 402, each comprising a primary stave 404 and a secondary stave 406. In some embodiments, the primary staves 404 are made of wood and the secondary staves 406 are made of or comprise metal or another non-wood material. In other embodiments, the primary staves 404 are made of or comprise metal while the secondary staves are made of wood.

While in the embodiment shown the secondary staves 406 are smaller than the primary staves 404, it should be understood that they may be substantially the same size or the secondary staves 406 may be larger than the primary staves 404. The primary staves 404 and/or the secondary staves 406 may all have the same or different sizes. The same material volume ratios described above with regard to the drum shell 200 can also be applied. It should also be understood that not all primary staves need be the same material and not all secondary staves need be the same material; for instance, in one embodiment, only half or fewer of the secondary staves are a non-wood such as metal. The shell can alternate between primary and secondary staves, or may have a different arrangement. Tertiary and additional stave groups are also possible. Many different embodiments are possible. Additionally, while in the embodiment shown the same number of primary staves as secondary staves are used, other embodiments are also possible.

It is understood that embodiments presented herein are meant to be exemplary. Although the present disclosure has been described in detail with reference to certain preferred configurations thereof both in the specification and in the claims, other versions are possible. Embodiments of the present disclosure can comprise any combination of compatible devices/features described herein and/or shown in the figures, and these embodiments should not be limited to those expressly illustrated and discussed. For instance and not by way of limitation, the appended claims could be modified to be multiple dependent claims so as to combine any combinable combination of elements within a claim set, or from differing claim sets. Claims depending on one independent claim could be modified so as to depend from a different independent claim. Therefore, the spirit and scope of the disclosure should not be limited to the versions described above.

While the foregoing written description of the disclosure enables one of ordinary skill to make and use what is considered presently to be the best mode thereof, those of ordinary skill will understand and appreciate the existence of variations, combinations, and equivalents of the specific embodiments, methods, systems, and examples herein. The disclosure should therefore not be limited by the above described embodiments, methods, systems, and examples. Furthermore, certain terminology has been used for the purposes of descriptive clarity, and not to limit the present disclosure. It is therefore intended that the following appended claims include all such alterations, modifications and permutations as fall within the true spirit and scope of the present disclosure. No portion of the disclosure is intended, expressly or implicitly, to be dedicated to the public domain if not set forth in the claims.

We claim:

1. A drum shell comprising a first wood ply, a second wood ply, and a non-wood ply between said first and second wood plies.

2. The drum shell of claim 1, wherein said first wood ply and said non-wood ply are part of a hybrid ply sheet.

3. The drum shell of claim 2, wherein said hybrid ply sheet further comprises said second wood ply.

4. The drum shell of claim 2, wherein said non-wood ply is the outermost ply of said hybrid ply sheet.

5. The drum shell of claim 2, wherein said non-wood ply is the innermost ply of said hybrid ply sheet.

6. The drum shell of claim 2, further comprising at least one additional ply sheet.

7. The drum shell of claim 2, further comprising first and second plywood ply sheets, wherein said hybrid ply sheet is between said first and second plywood ply sheets.

8. The drum shell of claim 2, further comprising a second hybrid ply sheet.

9. The drum shell of claim 1, wherein a mating surface of said non-wood ply is attached to said first wood ply, and wherein said mating surface is roughened.

10. The drum shell of claim 1, wherein non-wood comprises at least 5% of the volume of said drum shell.

11. The drum shell of claim 1, wherein said non-wood ply comprises a material selected from the group of metal, carbon fiber, plastic, and fiberglass.

12. The drum shell of claim 1, wherein said non-wood ply is a metal ply.

13. The drum shell of claim 1, wherein said non-wood ply is aluminum.

14. A method of manufacturing a hybrid drum shell, comprising:
combining a wood ply and a non-wood ply into a hybrid ply sheet; and
rolling said hybrid ply sheet into a substantially cylindrical shape.

15. The method of claim 14, further comprising combining said hybrid ply sheet and one or more plywood ply sheets to form a drum shell.

16. The method of claim 15, comprising combining said hybrid ply sheet with first and second plywood ply sheets to form said drum shell.

17. The method of claim 16, wherein said hybrid ply sheet is between said first and second plywood ply sheets.

18. The method of claim 14, further comprising increasing the surface area of a mating surface of said non-wood ply prior to attaching said mating surface of said non-wood ply to said wood ply.

19. The method of claim 18, wherein said mating surface of said non-wood ply is attached to said wood ply with an adhesive.

20. The method of claim 18, wherein the surface area of said mating surface of said non-wood ply is increased by roughening said mating surface.

21. The method of claim 20, wherein said non-wood ply is a metal ply.

22. A drum shell comprising:
a plurality of staves connected to form a generally cylindrical shape, said plurality of staves comprising a plurality of wood staves and a plurality of non-wood staves.

23. The drum shell of claim 22, wherein said non-wood staves are metal staves.

24. The drum shell of claim 22, wherein said non-wood staves are smaller than said wood staves.

25. The drum shell of claim 22, wherein said drum shell alternates between wood staves and non-wood staves.

26. The drum shell of claim 22, wherein all wood staves of said drum shell are approximately equally sized, and all non-wood staves of said drum shell are approximately equally sized.

27. The drum shell of claim 22, wherein all staves of said drum shell are approximately equally sized.
